(19) United States
(12) Patent Application Publication
(10) Pub. No.: US 2025/0132080 A1
(43) Pub. Date: Apr. 24, 2025

(54) Actuating Unit for an Electromagnet, Electromagnet, and Drive Unit

(71) Applicant: SVM Schultz Verwaltungs-GmbH & Co. KG, Memmingen (DE)

(72) Inventors: Thomas Schubert, Memmingerberg (DE); Ralf Raupold, Sontheim (DE); Wolfgang Abler, Holzgünz (DE)

(21) Appl. No.: 18/917,746

(22) Filed: Oct. 16, 2024

(30) Foreign Application Priority Data
Oct. 20, 2023 (DE) 102023128959.4

(51) Int. Cl. H01F 7/16; H01F 7/08; H01F 7/18

(52) U.S. Cl. CPC H01F 7/1607; H01F 7/081; H01F 7/1844; H01F 2007/086

(57) ABSTRACT

An actuating unit for an electromagnet for actuating an annular armature, wherein the actuating unit comprises a magnetic coil, a housing, and a magnetic field sensor integrated in the housing. Also disclosed is an electromagnet having such an actuating unit as well as a drive unit having such an electromagnet.

### CROSS-REFERENCE TO RELATED APPLICATIONS

This non-provisional application claims the benefit of, and priority to, German Application No. 102023128959.4, entitled Actuating Unit for an Electromagnet, Electromagnet, and Drive Unit, filed on Oct. 20, 2023, which is incorporated by reference in its entirety.

### FIELD OF THE DISCLOSURE

The present disclosure generally relates to an actuating unit for an electromagnet, an electromagnet having such an actuating unit, and a drive unit having such an electromagnet.

### BACKGROUND

Drive units can be used, for example, to transmit a rotational movement between a shaft and a rotational drive element. For example, the rotational drive element can be driven by an electric motor or another unit and can transmit a rotational movement to the shaft. The shaft can be connected, for example, to an axle or a wheel of a vehicle to drive it. The reverse variant of the force flow is also possible.

In numerous applications, it is desirable to ensure that the coupling between shaft and rotational drive element is switchable. The coupling can thus be temporarily suspended. For example, in this way, decoupling of a drive unit of a vehicle can take place so that it can roll as much as possible without engine braking effect. Moreover, such a switching capability can be used, for example, to selectively switch on and off the force transmission to an axle, for example to implement an activatable all-wheel-drive.

### SUMMARY

An actuating unit for an electromagnet for actuating an annular armature, which is not associated with the actuating unit, wherein the actuating unit includes: a magnetic coil, wherein the magnetic coil is annular, a housing attached to a radial outside of the magnetic coil, and a magnetic field sensor fastened to or integrated in the housing.

An electromagnet for controlling a coupling state between a shaft not associated with the electromagnet and a rotational drive element not associated with the electromagnet, wherein the electromagnet comprises: an annular armature that surrounds the shaft on a section of the shaft, and the actuating unit.

A drive unit comprising: a shaft, and the electromagnet, wherein the annular armature of the electromagnet is arranged on a radial outside of the shaft and is axially displaceable relative to the shaft.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 shows an exploded perspective view of an electromagnet;

FIG. 2 shows an assembled perspective view of the electromagnet; and

FIG. 3 shows a sectional view of the electromagnet.

### DETAILED DESCRIPTION

Disclosed is an actuating unit for an electromagnet, an electromagnet having such an actuating unit, and a drive unit having such an electromagnet. The disclosed actuating unit, electromagnet, and drive unit can have benefits, for example, lower circuitry expenditure.

The actuating unit is used to actuate an annular armature not associated with the actuating unit. The actuating unit comprises a magnetic coil, which can be annular. The actuating unit comprises a housing which is attached to the magnetic coil on the radial outside. Moreover, the actuating unit comprises a magnetic field sensor which is fastened to or integrated in the housing.

The disclosed actuating unit can achieve a particularly high level of integration. Due to the integration of the magnetic field sensor, a functionality is provided which enables a detection of an armature position in conjunction with a magnetic field generator not associated with the actuating unit. Separately fastening the magnetic field sensor on a drive unit and the additional wiring expenditure connected thereto and also providing additional drilled holes for the fastening of the magnetic field sensor and its wiring can thus advantageously be omitted.

An actuating unit is understood herein as a unit which is designed to displace an armature. In aspects, the armature is typically an at least substantially annular armature. In some embodiments, at least a part or a section of the armature is annular. This can typically be formed peripherally around the circumference of a shaft and/or can be arranged on the radial outside of a shaft. The magnetic coil is typically arranged on the radial outside in relation to the armature and can axially move the armature by generating a magnetic field. An axial movement is understood herein as a movement along an axis which is specified by the magnetic coil. In aspects, the axial movement can be relative to a centre axis of the magnetic coil. This centre axis can be identical to a centre axis of the annular armature or an annular section of the armature and the shaft. The description just given relates not only to the actuating unit, but also to a complete electromagnet and to the drive unit. Both the actuating unit and the armature are components of the electromagnet in a finished electromagnet. However, the actuating unit is a component of the electromagnet separate from the armature and is used for actuating the armature.

A magnetic field sensor can be understood as a sensor which can detect a magnetic field. In aspects, the magnetic field sensor can be a Hall sensor. In such a Hall sensor, it is typically provided that a defined current is conducted through the sensor and a voltage or a current is measured which is generated by an existing magnetic field. An inference can thus be drawn about the strength of the existing magnetic field. This permits in particular sensing of a current setting or a position of the armature if a magnetic field generator, which generates a magnetic field to be sensed by the magnetic field sensor, is connected to the armature in such a way that an axial movement of the armature also results in a corresponding axial movement of the magnetic field generator. This can be understood under the concept of a connection embodied as fixed with respect to axial displacement. This can be embodied as rigid, for example, or it can be embodied, for example, in that an element containing the magnetic field generator, such as an interface element, is supported on a planar surface of the armature and is expediently pressed against this planar surface.

In aspects, the magnetic field sensor is arranged axially spaced apart from the magnetic coil. The term “axial” can relate here in particular to a direction which is specified by a centre axis of the magnetic coil. In aspects, decoupling of the magnetic field sensor from a magnetic field generated by the magnetic coil can thus take place. It is thus possible to prevent, for example, the magnetic field generated by the magnetic coil from reaching the magnetic field sensor in an excessive strength and thus negatively affecting the measurement to be carried out by the magnetic field sensor.

In aspects, a shielding magnetic material and/or a magnetic body for magnetically shielding the magnetic field sensor from the magnetic coil is arranged between the magnetic field sensor and the magnetic coil. In aspects, the magnetically shielding material can be designed as a magnetic body or can be a component of a magnetic body. Such a shielding magnetic material can deflect the magnetic field generated by the magnetic coil, for example, so that its magnetic field lines are substantially shielded from the magnetic field sensor. In this way, it is also possible for the least possible influence of the measurement to be carried out by the magnetic field sensor to take place due to the magnetic field generated by the magnetic coil.

A magnetic body can, for example, surround the circumference of the magnetic coil on the outside. In aspects, an annular section of the magnetic body can be provided for this purpose. Additionally or alternatively, a disc-shaped section of the magnetic body can be present. This can have a centre hole, through which the shaft can pass. The disc-shaped section can induce the shielding effect.

In aspects, the actuating unit can comprise one or more connection lines of the sensor, which are arranged radially outside and/or engaging around the shielding magnetic material. The concept of an arrangement located on the radial outside can be understood to mean that the connection lines have a greater distance to a centre axis defined by the magnetic coil. The concept of an arrangement engaging around can mean that the connection lines are arranged outside the shielding magnetic material if the centre axis is taken as the reference. A connection of the sensor, such as an electrical connection, can thus be ensured in a simple manner. Drilling through the shielding magnetic material can advantageously be avoided in this way.

An electrical connection for connecting a plug can be formed in the housing. The electrical connection can be connected to the magnetic coil and/or to the magnetic field sensor. The plug is not part of the actuating unit, but is typically used for the electrical connection of the components of the actuating unit. In aspects, the magnetic coil can thus be supplied with a current which results in the generation of a magnetic field to move the armature. In aspects, the magnetic field sensor can be supplied with a current which can then be at least partially deflected by an applied magnetic field. As a result of the deflection, a current and/or a voltage is generated which can then also be read out by means of connection lines that can be guided via the electrical connection.

The electrical connection can be arranged in the housing at a longitudinal end opposite to the magnetic field sensor. An advantageous line guidance is thus enabled, which can be embodied as particularly slender. The definition of longitudinal ends can be oriented to a coil axis or centre axis of the magnetic coil.

The housing can comprise an elongated projection. In aspects, the magnetic field sensor can be arranged in the elongated projection. The elongated projection can extend along a recognizable longitudinal direction. This does not preclude it also having slight angles in comparison thereto. In aspects, it can be longer than its width and height, in particular at least twice as long or at least three times as long as its width and/or height. With the elongated projection, it is possible to avoid the housing having to be designed in accordance with the shape of the magnetic coil along the entire required axial extension. The elongated projection can extend parallel or at least essentially parallel to a longitudinal axis or centre axis of the magnetic coil or can be aligned parallel or at least essentially parallel thereto. In aspects, the elongated projection can have a smaller cross-sectional surface, smaller by at least 50%, at least 80%, or at least 90%, viewed in a plane transverse to the longitudinal axis or centre axis of the magnetic coil than the magnetic coil. A cross-sectional surface is viewed here in particular as the entire enclosed space.

The actuating unit can comprise a sensor support, which is fastened on the shielding magnetic material and/or on the magnetic body and/or on the magnetic coil and is mechanically firmly connected to an end of the elongated projection at which the magnetic field sensor is arranged. The mentioned end of the elongated projection can thus be mechanically stabilized. For example, the sensor support can comprise a sleeve into which the elongated projection is inserted and which abuts the elongated projection on all sides. A protection of the housing against soiling can thus also be implemented, for example. Another fastening, for example a screw connection or an adhesive bond, is also possible, however. In aspects, it can be provided that the sensor support is fastened on the magnetic coil, in particular by means of one or more pins. A passage can be provided in the magnetic body for this purpose, through which the sensor support and/or the pins pass. In aspects, it can be provided that the sensor support completely or partially engages around the end of the elongated projection and protects it from soiling.

In aspects, the actuating unit can comprise one or more connection lines of the magnetic coil which can be guided in the housing and/or can be connected to the connection. A compact embodiment and protected line guidance are thus implemented.

The disclosure furthermore relates to an electromagnet for controlling a coupling state between a shaft not associated with the electromagnet and a rotational drive element not associated with the electromagnet. The electromagnet comprises an annular armature, which is designed to surround the shaft at a section of the shaft, to surround it along a complete circumference of the shaft. The electromagnet furthermore comprises an actuating unit as described herein, wherein the magnetic coil of the actuating unit is arranged on the radial outside of the armature. All embodiments and variants described herein can be used with respect to the actuating unit.

The annular armature can be designed as completely annular, for example. Alternatively, for example, only a part of the armature can also be designed as annular.

According to one embodiment, the electromagnet can comprise an interface element. This can be fastened on the armature so it is fixed against axial displacement. It can also abut the armature and can be pre-tensioned against the armature, in particular by means of a spring. It is also ensured with such an embodiment that the interface element accepts an axial movement of the armature. The interface element can be embodied as annular. The magnetic field generator can be arranged in the interface element and/or fastened on the interface element so it is fixed against axial displacement. The interface element is typically an element connected to the armature so it is fixed against axial displacement. It can be used to transmit the movement of the armature to other components, on which this movement causes a function.

The actuating unit can comprise a sensor support, which is connected in a mechanically fixed manner to an end of the elongated projection on which the magnetic field sensor is arranged. Reference is made to the statements already provided above in this regard. The sensor support can represent a twist lock for the interface element. For the case of an annular interface element, the interface element is thus prevented from executing undesired rotational movements around its axis, which is typically identical to an axis of the armature.

The interface element can comprise a first projection and a second projection. These can laterally abut the sensor support and can thus implement a twist lock. The sensor support is thus used as a reliable guide, which is easy to implement, for the interface element.

The electromagnet can comprise a tube. This can be fixedly connected to the armature and can be used for mounting the armature in an outer housing or a magnetic body. Alternatively or additionally, it can be used for mounting an interface element inside the tube. The tube can therefore in particular provide an external running surface, which is guided by a surrounding housing or magnetic body, by which the armature is also guided. The interface element, particularly the interface element already described above, can be guided inside the tube and can therefore be stabilized.

The disclosure furthermore relates to a drive unit. The drive unit comprises a shaft and an electromagnet as described herein. All embodiments and variants described herein can be used with respect to the electromagnet and with respect to the actuating unit of the electromagnet. The armature of the electromagnet is arranged on the radial outside of the shaft and is axially displaceable relative to the shaft. A drive unit can thus be provided in which an axial displacement of an armature can be carried out by the drive unit described herein. The advantages already mentioned in this case can therefore advantageously be achieved.

According to one advantageous embodiment, the drive unit comprises a rotational drive element. This comprises a first contact surface. The armature, or an element connected in a rotationally-fixed manner to the armature, can comprise a second contact surface. It can be provided that in a first position of the armature, the first contact surface is engaged with the second contact surface. In aspects, it can also be provided that in a second position of the armature, the second contact surface is spaced apart from the first contact surface. An advantageous switchable embodiment of the force transmission can thus be implemented easily. The armature can be actuated using the magnetic coil, and depending on the position of the armature, a force transmission takes place in the first position and no force transmission takes place in the second position. The two contact surfaces can comprise respective gear teeth for this purpose, for example, which can mesh in the first position and are spaced apart from one another in the second position.

In aspects, the drive unit can comprise a restoring spring, which is designed to pre-tension the armature in the second position. The force transmission is thus interrupted in an idle position and the force transmission can be activated by energizing the magnetic coil. The reverse embodiment is also possible.

In aspects, the drive unit can comprise a magnetic field generator. This can generate a measurement magnetic field. Such a measurement magnetic field can be detected by the magnetic field sensor of the actuating unit. The magnetic field generator can be attached to the armature, or to an element connected to the armature so it is fixed against axial displacement. In aspects, it can be provided that the magnetic field generator is arranged adjacent to the magnetic field sensor in at least one position of the armature and/or the magnetic field generator is arranged in such a way that the measurement magnetic field is detectable by the magnetic field sensor in at least one position of the armature. Sensing of the setting or position of the armature and possibly connected components can thus take place, in such a way that the magnetic field detected by the magnetic field sensor is dependent on the current position of the armature.

In aspects, it can be provided that the actuating unit has a total maximum diameter of at most 90 mm, at most 100 mm, at most 150 mm, at most 250 mm, at most 300 mm, or at most 500 mm. This has proven to be advantageous for typical applications. In aspects, this can relate to the radius of the magnetic coil. It can also relate to an element located farthest outward in comparison to a centre axis of the magnetic coil. The embodiments described herein can be used in conjunction with a solenoid. In aspects, they can be used in conjunction with a drivetrain, for example an electric drivetrain or also a conventional axle drive. Depending on the vehicle architecture, for example, an electric machine or a component of an all-wheel-drive can be coupled to and decoupled from the drivetrain. Losses in the drivetrain can thus be reduced.

For example, an air gap provided for the armature can be at least 2 mm or at least 3 mm and/or at most 4 mm or at most 5 mm, in particular 3 mm or 4 mm. This has proven to be advantageous for typical applications. In aspects, this can relate to a difference between the above-mentioned first position and the above-mentioned second position. These positions can correspond to end positions of the movement of the armature.

The magnetic field generator can be a permanent magnet. Alternatively, an electromagnet can also be used.

In aspects, an anti-adhesive disc can be arranged between the armature and a yoke. It is thus possible to prevent detaching the armature from the yoke from being obstructed. In aspects, such an anti-adhesive disc can be used for a magnetic separation.

In aspects, it can be provided that a loadbearing bearing seat in a transmission is not broken through by the embodiment provided herein. Carrying capacity and running accuracy are thus not impaired. In aspects, the embodiment described herein can be used for a transmission output shaft. However, it is also usable for a driveshaft, for example.

In aspects, a direct actuation in a transmission enables a compact design, with technical and commercial advantages at the same time. Complex hydraulic actuations by means of valves, pumps, and tubing can thus be omitted. This also applies to a mechanical actuation from the outside, which is usually accompanied by geometrically complex components for implementing the movement.

Due to the integration of a sensor directly into a magnetic actuator, in particular a further seal point can be omitted, which causes the overall system to be more robust. Furthermore, the assembly is typically simplified and the susceptibility to error is therefore also reduced here.

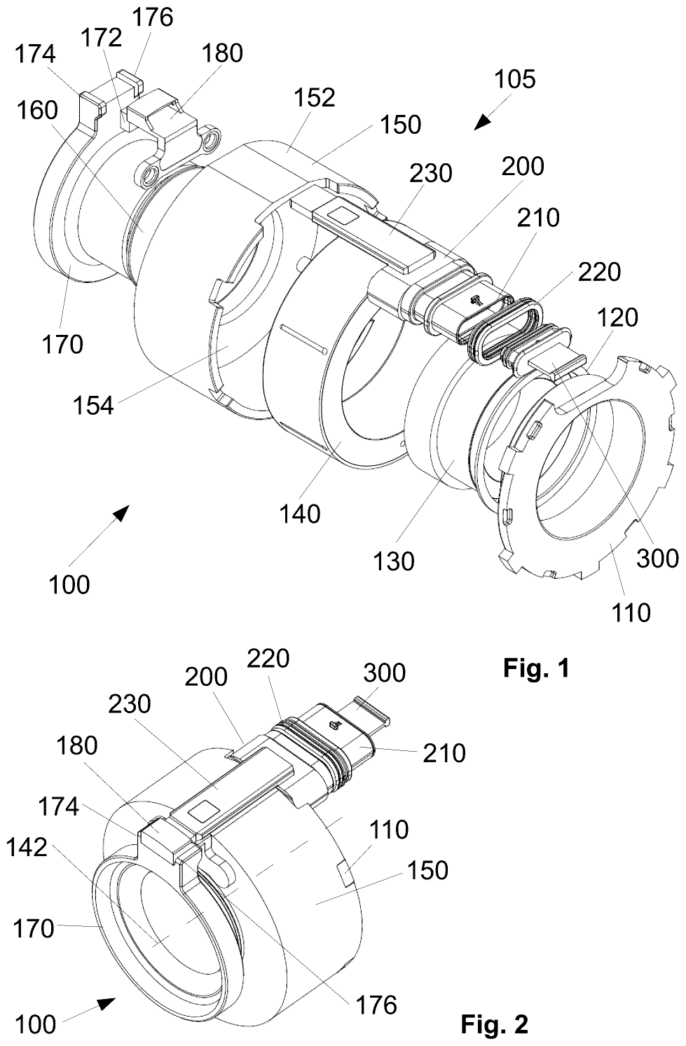

FIG. 1 shows, solely schematically, an electromagnet 100 in an exploded view. The electromagnet 100 is closed on one side by a yoke 110. An anti-adhesive disc 120 for providing a magnetic separation is arranged directly adjoining thereon.

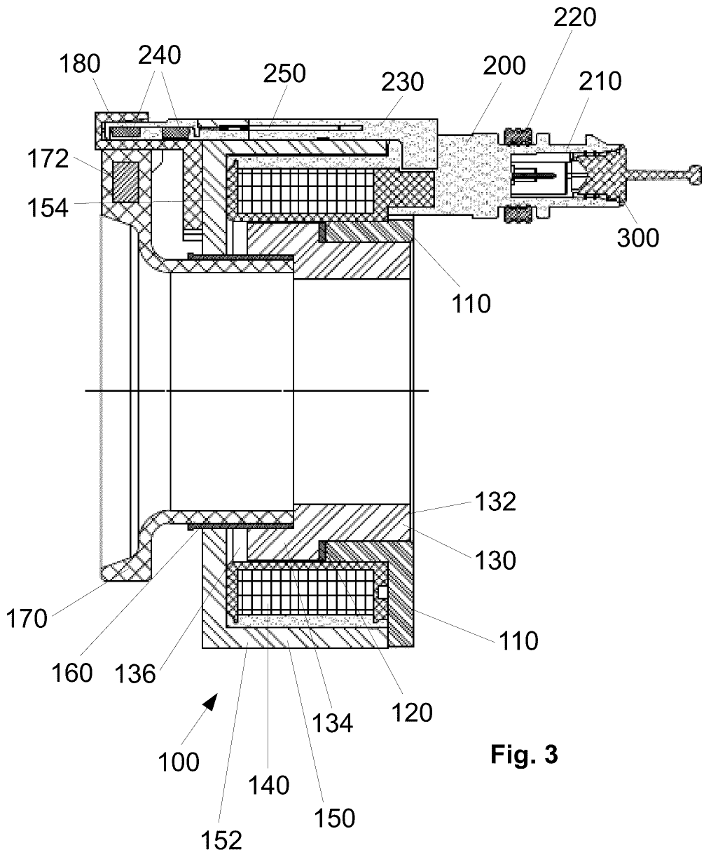

The electromagnet 100 comprises an armature 130. This is embodied as axially movable, as will be explained in more detail hereinafter with reference to FIG. 3.

The electromagnet 100 comprises a magnetic coil 140. This is used to generate a magnetic field upon energization and thus to move the armature 130. In the assembled state, the magnetic coil 140 is arranged on the radial outside of the armature 130 and is spaced apart from the armature 130.

The electromagnet 100 comprises a magnetic body 150. This is formed from a magnetic material, for example from iron. The magnetic body 150 comprises an annular section 152 and a disc-shaped section 154, which is arranged on the radial inside in comparison thereto. This is used for the magnetic shielding, as will be explained in more detail hereinafter. The magnetic body 150 is therefore a magnetically shielding element.

The electromagnet 100 furthermore comprises a tube 160. This is connected to the armature 130 so it is rotationally fixed and fixed against axial displacement and can thus be used for a force transmission. The tube 160 abuts the outside of the disc-shaped section 154 of the magnetic body 150. The armature 130 is thus guided and stabilized via the tube 160.

On a side opposite to the yoke 110, the electromagnet 100 comprises an interface element 170. This is connected to the tube 160 so it is rotationally fixed and fixed against axial displacement. In aspects, it can therefore be provided that the interface element 170 is mounted by the tube 160. For example, it can effectuate and release a coupling with a rotational drive element in a manner which is described elsewhere herein, depending on the position of the armature 130. The coupling can therefore be activated or also deactivated by an axial displacement of the armature 130. Instead of a rigid embodiment fixed against axial displacement, the interface element 170 can also support itself on a planar surface of the armature 130 without being rigidly connected thereto. A clearance fit can be implemented here in particular. A pressure, which is exerted on the interface element 170 in the direction toward the armature 130, can ensure the movement running in the same direction of interface element 170 and armature 130. Such a pressure can be generated in particular by means of a spring (not shown). A magnetic field generator 172, the function of which will be described in more detail hereinafter, is arranged in the interface element 170.

A sensor support 180, which is used to increase the mechanical stability, is fastened on the magnetic body 150. This will be described in more detail hereinafter. Alternatively, the sensor support 180 could be fastened, for example, on the magnetic coil 140.

The electromagnet 100 comprises a housing 200. This is fastened to the magnetic coil 140 on the radial outside of the magnetic coil 140, i.e., on the outside on a section along the circumference of the magnetic coil 140. An electrical connection 210, on which a seal 220 is arranged on the outside, is attached to the housing 200. The electrical connection 210 is embodied in the present case as a socket. This enables a plug (not shown) to be plugged in for the electrical contacting of the electrical components present, the magnetic coil 140 and a magnetic field sensor still to be described hereinafter. An elongated projection 230 is arranged on the housing 200, which extends from an area of the housing 200 having larger cross section parallel to a centre axis of the magnetic coil 140. The elongated projection 230 engages in the sensor support 180, so that the elongated projection 230 is thus mechanically stabilized. Moreover, the housing 200 is thus protected from soiling in the area of the projection 230 or at its end engaging in the sensor support 180.

The housing 200 having the components contained therein, as well as the magnetic coil 140, the magnetic body 150, and the sensor support 180, together form an actuating unit 105.

FIG. 1 furthermore shows a plug 300 not associated with the electromagnet 100, which is plugged into the electrical connection 210. The plug 300 can be an electrical connection or, for example, a transport safeguard. The plug 300 is removable in principle from the electrical connection 210. The plug 300 can be connected, for example, to a cable to contact the electrical components present in the electromagnet 100.

FIG. 2 shows the electromagnet 100 in an assembled state. Reference is made to the description already given of FIG. 1 with respect to the individual components.

A centre axis 142 of the magnetic coil 140 is also shown in FIG. 2. It forms an axis of symmetry of the magnetic coil 140 and defines an axial extension.

The plug 300 already described with reference to FIG. 1 is also shown in FIG. 2 and likewise in FIG. 3, described hereinafter. It can be used as a transport safeguard.

FIG. 3 shows the electromagnet 100 in a sectional view. Reference is made in principle to the description of FIGS. 1 and 2 with respect to the components.

The armature 130 is divided here into a radially inside section 132 and a radially outside section 134. The radially outside section 134 overlaps axially only partially with the radially inside section 132 and extends farther to the left than the radially inside section 132 in the illustration of FIG. 3. The radially outside section 134 engages around the tube 160 as shown. The interface element 170 is clamped in the tube 160 on the radial inside of the tube 160.

The magnetic coil 140 is arranged on the radial outside of the armature 130 as shown. It therefore permits an axial movement of the armature 130 by a generated magnetic field. An air gap 136 is provided adjacent to the armature 130 as the movement space for this purpose. The armature 130 is therefore located in the illustration shown in FIG. 3 in a position moved all the way to the right and could be moved to the left from this position.

As shown, a magnetic field sensor 240 is arranged in the elongated projection 230 of the housing 200. This is located at an opposite end in comparison to the electrical connection 210. A group of connection lines 250, which engage around the outside of the magnetic body 150 and are only partially shown here, but in principle extend up to the electrical connection 210, is used for connecting the magnetic field sensor 240. This permits electrical contacting of the magnetic field sensor 240. The magnetic field sensor 240 is designed in the present case as a typical Hall sensor. As shown, the disc-shaped section 154 of the magnetic body 150 is located between the magnetic field sensor 240 and the magnetic coil 140. This permits shielding of the magnetic field generated by the magnetic coil 140 from the magnetic field sensor 240, due to which influencing of a magnetic field measurement by the magnetic field generated by the magnetic coil 140 is minimized.

The above-mentioned magnetic field generator 172 is arranged in the interface element 170. The magnetic field generator 172 is designed as a permanent magnet and is located directly on the radial inside of the magnetic field sensor 240. The magnetic field sensor 240 enables the measurement of a magnetic field generated by the magnetic field generator 172. Since the magnetic field generator 172 is connected to the armature 130 so it is fixed against axial displacement, this enables an exact determination of the position of the armature 130. The circuitry expenditure is minimized by the embodiment integrated in the housing 200 and the drilling of additional holes or the guiding of additional connection lines is not required. In aspects, a particularly stable, compact, and easy-to-handle construction thus results.

As can also be seen in FIG. 3, the sensor support 180 stabilizes the left end of the housing 200 in FIG. 3. Furthermore, the interface element 170 and the sensor support 180 are expediently embodied so that the interface element 170 and therefore also the magnetic field generator 172 are twist-locked. The magnetic field generator 172 therefore remains location-oriented in relation to the magnetic field sensor 240. As can be seen in FIGS. 1 and 2, the interface element 170 comprises two projections 174, 176 for this purpose, which laterally abut the sensor support. The projections 174, 176 prevent twisting of the annular interface element 170. Alternatively, a twist lock could be implemented, for example, by providing a longitudinal groove in the sensor support 180 and an elongated projection engaged therewith on the interface element 170, or vice versa.

The armature 130 is axially displaceable, as already mentioned. The interface element 170 is therefore also axially displaceable. In a typical implementation of a drive element, a shaft (not shown) passes through the armature 130 and the interface element 170. An element can be connected thereto in a rotationally fixed but axially displaceable manner, which element is displaceable by the interface element 170. In the state of the armature 130 shown in FIG. 3, the element connected to the shaft is typically disengaged from a rotational drive element. However, if the magnetic coil 140 is energized and the armature 130 is thus moved to the left, the element connected to the shaft is engaged with a rotational drive element, wherein a rotational movement can be transmitted between the shaft and the rotational drive element.

A restoring spring (not shown) can be provided to pre-tension the armature 130 and the components connected thereto in the state shown in FIG. 3.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An actuating unit for an electromagnet for actuating an annular armature, which is not associated with the actuating unit, wherein the actuating unit comprises:
a magnetic coil, wherein the magnetic coil is annular;
a housing attached to a radial outside of the magnetic coil; and
a magnetic field sensor fastened to or integrated in the housing.

2. The actuating unit according to claim 1, wherein the magnetic field sensor is arranged axially spaced apart from the magnetic coil.

3. The actuating unit according to claim 1, further comprising a shielding magnetic material, a magnetic body, or both a shielding magnetic material and a magnetic body, for magnetically shielding the magnetic field sensor from the magnetic coil is arranged between the magnetic field sensor and the magnetic coil.

4. The actuating unit according to claim 3, wherein the magnetic field sensor comprises one or more connection lines which are arranged radially outside the shielding magnetic material, engage around the shielding magnetic material, or are arranged radially outside and engage around the shielding magnetic material.

5. The actuating unit according to claim 3, further comprising a sensor support fastened on the shielding magnetic material, the magnetic body, the magnetic coil, or a combination thereof, wherein the housing comprises an elongated projection in which the magnetic field sensor is arranged, wherein the sensor support is connected in a mechanically fixed manner to an end of the elongated projection on which the magnetic field sensor is arranged.

6. The actuating unit according to claim 5, wherein the sensor support completely or partially engages around the end of the elongated projection and protects it from soiling.

7. The actuating unit according to claim 1, wherein an electrical connection for connecting to a plug is formed in the housing, wherein the electrical connection is connected to the magnetic coil and to the magnetic field sensor.

8. The actuating unit according to claim 7, wherein the electrical connection is arranged in the housing at a longitudinal end opposite to the magnetic field sensor.

9. The actuating unit according to claim 1, wherein the housing comprises an elongated projection in which the magnetic field sensor is arranged.

10. The actuating unit according to claim 9, wherein the elongated projection is aligned parallel or essentially parallel to a centre axis of the magnetic coil.

11. The actuating unit according to claim 1, wherein the magnetic coil comprises one or more connection lines which are guided in the housing, connected to an electrical connection, wherein the electrical connection connects to a plug that is formed in the housing.

12. An electromagnet for controlling a coupling state between a shaft not associated with the electromagnet and a rotational drive element not associated with the electromagnet, wherein the electromagnet comprises:
an annular armature that surrounds the shaft on a section of the shaft; and
the actuating unit of claim 1, wherein the magnetic coil of the actuating unit is arranged on a radial outside of the annular armature.

13. The electromagnet according to claim 12, further comprising:
a magnetic field generator which generates a measurement magnetic field and which is attached to the annular armature or to an element connected to the annular armature so it is fixed against axial displacement,
wherein i) the magnetic field generator is arranged adjacent to the magnetic field sensor in at least one position of the annular armature, ii) the magnetic field generator is arranged such that in at least one position of the annular armature the measurement magnetic field is detectable by the magnetic field sensor, or iii) both i) and ii).

14. The electromagnet according to claim 13, further comprising:
an interface element fastened on the annular armature so it is fixed against axial displacement, or which abuts the annular armature and is pre-tensioned against the annular armature,
wherein the magnetic field generator is arranged in the interface element, is fastened on the interface element, or both arranged in and fastened on the interface element so it is fixed against axial displacement.

15. The electromagnet according to claim 14, wherein the housing of the actuating unit comprises an elongated projection, wherein the actuating unit further comprises a sensor support connected in a mechanically fixed manner to one end of the elongated projection on which the magnetic field sensor is arranged, and wherein the sensor support represents a twist lock for the interface element.

16. The electromagnet according to claim 15, wherein the interface element comprises a first projection and a second projection, wherein each of the first projection and the second production laterally abuts the sensor support and implements the twist lock.

17. The electromagnet according to claim 12, further comprising:
a tube fixedly connected to the annular armature and which is used for i) mounting the annular armature in an outer housing or a magnetic body, ii) mounting an interface element inside the tube, or iii) both i) and ii).

18. A drive unit comprising:
a shaft; and
the electromagnet of claim 12;
wherein the annular armature of the electromagnet is arranged on a radial outside of the shaft and is axially displaceable relative to the shaft.

19. The drive unit according to claim 18, wherein the shaft and the annular armature are spaced apart from one another in each position of the annular armature.

20. The drive unit according to claim 18, further comprising a rotational drive element comprising a first contact surface,
wherein the annular armature, or an element connected to the annular armature so it is fixed against axial displacement, comprises a second contact surface,
wherein the first contact surface is engaged with the second contact surface in a first position of the annular armature,
wherein the second contact surface is spaced apart from the first contact surface in a second position of the annular armature,
wherein the drive unit further comprises a restoring spring to pre-tension the annular armature in the second position.
